(19) United States
(12) Patent Application Publication
(10) Pub. No.: US 2025/0005067 A1
(43) Pub. Date: Jan. 2, 2025

(54) Sentence generation method, device and electronic device based on large language model

(71) Applicant: BEIJING BAIDU NETCOM SCIENCE TECHNOLOGY CO., LTD., Beijing (CN)

(72) Inventors: Yushen Chen, Beijing (CN); Guangyao Han, Beijing (CN); Lei Su, Beijing (CN); Hongda Yue, Beijing (CN); Yi Wang, Beijing (CN); Yunjing An, Beijing (CN); Lin Chang, Beijing (CN)

(73) Assignee: BEIJING BAIDU NETCOM SCIENCE TECHNOLOGY CO., LTD., Beijing (CN)

(21) Appl. No.: 18/745,859

(22) Filed: Jun. 17, 2024

(30) Foreign Application Priority Data
Dec. 20, 2023 (CN) 202311764829.4

(51) Int. Cl. G06F 16/383; G06F 16/33; G06F 40/30

(52) U.S. Cl. CPC G06F 16/383; G06F 16/3347; G06F 40/30

(57) ABSTRACT

The disclosure provides a sentence generation method based on a large language model including: obtaining a query sentence, in which the query sentence has at least one candidate description object; performing semantic recognition on the query sentence to obtain first semantic information and second semantic information corresponding to the query sentence, in which categories of the first semantic information and the second semantic information are different; inputting the at least one candidate description object and the first semantic information into the large model, to identify a target description object from the at least one candidate description object based on the large model; selecting target service data from at least one piece of service data corresponding to the target description object based on the second semantic information; and generating a reply sentence corresponding to the query sentence according to the target service data.

### CROSS-REFERENCE TO RELATED APPLICATION

This application is based upon and claims the priority to Chinese Patent Application No. 202311764829.4, filed on Dec. 20, 2023, the entire contents of which are incorporated herein by reference.

### TECHNICAL FIELD

The disclosure relates to a field of computer technology, in particular to a field of artificial intelligence (AI) technology such as deep learning (DL), natural language processing (NLP), larger language model, and in particular to a sentence generation method based on a large language model, and an electronic device.

### BACKGROUND

The NLP is an important direction in a field of computer science and artificial intelligence, and refers to that computers process information such as shapes, sounds, and meanings of natural languages, that is, operations and processing of input, output, recognition, analysis, understanding, and generation of words, phrases, sentences, and chapters. The NLP studies various theories and methods that can realize effective communication between humans and computers using the natural language. A specific representation form of the NLP includes machine translation, text summarization, text classification, text proofreading, information extraction, intelligent question answering, and the like. When implementing the intelligent question answering, how to accurately generate a reply sentence adapted to a query sentence becomes an important concern.

### SUMMARY

According to a first aspect of the disclosure, a sentence generation method is provided, the method includes:
obtaining a query sentence, in which the query sentence has at least one candidate description object;
performing semantic recognition on the query sentence to obtain first semantic information and second semantic information corresponding to the query sentence, in which categories of the first semantic information and the second semantic information are different;
inputting the at least one candidate description object and the first semantic information into a large model, to identify a target description object from the at least one candidate description object based on the large model;
selecting target service data from at least one piece of service data corresponding to the target description object based on the second semantic information; and
generating a reply sentence corresponding to the query sentence according to the target service data.

According to a second aspect of the disclosure, an electronic device is provided, and includes:
at least one processor; and
a memory communicatively coupled to the at least one processor; in which,
the memory stores instructions executable by the at least one processor, in which the instructions are executed by the at least one processor, so that the at least one processor may execute the sentence generation method according to the first aspect.

### BRIEF DESCRIPTION OF THE DRAWINGS

The drawings are intended to better understand the solution, and do not constitute a limitation to the disclosure. in which,

FIG. 1 is a schematic flowchart illustrating a sentence generation method according to an embodiment of the disclosure.

FIG. 1a is a schematic diagram illustrating recognition of first semantic information corresponding to a query sentence based on a large model according to the disclosure.

FIG. 2 is a schematic flowchart illustrating a sentence generation method according to another embodiment of the disclosure.

FIG. 3 is a schematic flowchart illustrating a sentence generation method according to yet another embodiment of the disclosure.

FIG. 4 is a flowchart illustrating an index question answering algorithm for intelligent investment research according to the disclosure.

FIG. 5 is a block diagram of a sentence generation apparatus according to an embodiment of the disclosure.

FIG. 6 is a block diagram of an electronic device for implementing a sentence generation method according to an embodiment of the disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following descriptions.

Embodiments of the disclosure relates to a field of artificial intelligence (AI) technology such as DL, NLP, a large language model, and the like.

Artificial Intelligence is abbreviated as AI, AI is a new science of technology that studies and develops theories, methods, technologies and application systems configured to simulate, extend and expand human intelligence.

DL learns inherent law and representation hierarchy of sample data, and information obtained in the learning process is of great help in interpretation of data such as words, images and sound. The final goal of DL is that the machine may have analytic learning ability like human beings, which may recognize data such as words, images, sound, etc.

NLP is an important direction in the field of computer science and AI. NLP is used to study all kinds of theories and methods that may achieve effective communication between human and computer by using the natural language.

Large language models refer to machine learning models obtained by training based on a large-scale corpus and having a large number of parameters and complex structures. These models can be applied to deal with large-scale data and complex problems.

It should be noted that, in the technical solution of the disclosure, the collection, storage, use, processing, transmission, provision and disclosure of personal information of users involved all meet provisions of relevant laws and regulations, and do not violate public order and good customs.

The sentence generation method and apparatus, the electronic device, and the storage medium of the embodiments of the disclosure are described below with reference to the accompanying drawings.

It should be noted that an execution body of the sentence generation method in the embodiments is the sentence generation apparatus. The apparatus may be implemented by software and/or hardware, the apparatus may be configured in an electronic device, and the electronic device may include, but is not limited to, a terminal, a server, and the like.

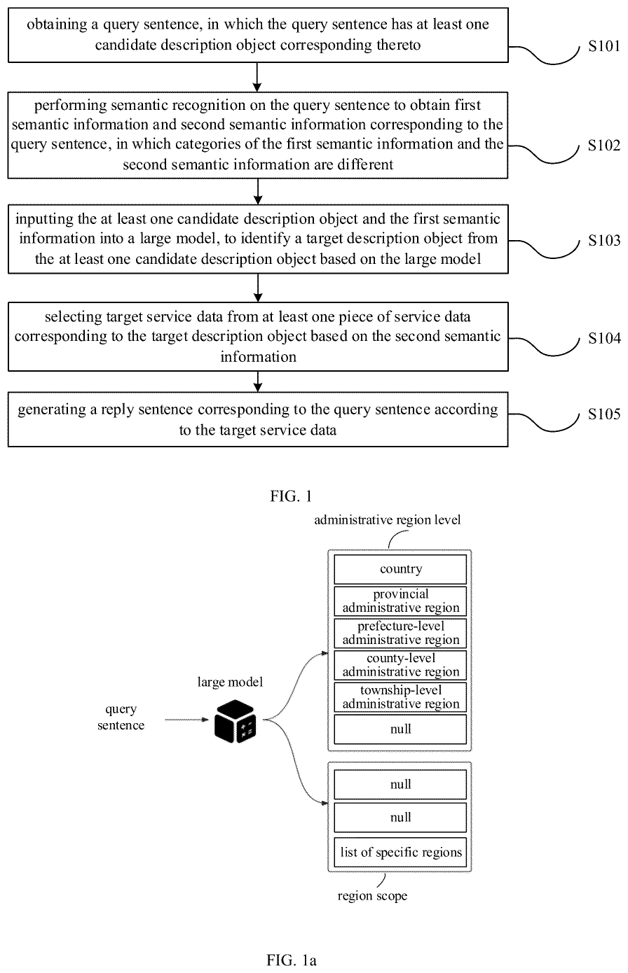

FIG. 1 is a schematic flowchart illustrating a sentence generation method according to an embodiment of the disclosure.

As shown in FIG. 1, the sentence generation method includes the following steps.

At step S101, a query sentence is obtained, the query sentence has at least one candidate description object corresponding thereto.

The query sentence may refer to a sentence proposed by a user to the execution body of the embodiment of the disclosure and used for querying specified information.

The description object may be an object body described by a sentence, for example, may be a core index in index data. For example, in index data “the number of imports of automobiles and automobile chassis: accumulated value: month”, “the number of imports of automobiles and automobile chassis” is a corresponding description object, that is, a core index. The candidate description object refers to a description object that may be used as a corresponding body of the query sentence.

In the embodiments of the present disclosure, when obtaining the candidate description object corresponding to the query sentence, the candidate description object corresponding to the query sentence may be obtained based on a pre-trained description object recognition model, or may be obtained based on a third-party description object recognition device, which is not limited herein.

At step S102, semantic recognition is performed on the query sentence to obtain first semantic information and second semantic information corresponding to the query sentence, in which categories of the first semantic information and the second semantic information are different.

Semantic information may be used to describe a meaning, an intent, and a relationship of a corresponding sentence. The first semantic information and the second semantic information are different types of semantic information obtained by performing the semantic recognition on the query sentence.

That is, in the embodiment of the disclosure, the semantic recognition may be performed on the query sentence at different dimensions, to obtain the first semantic information and the second semantic information, so as to provide a reliable judgment basis for subsequently determining a target description object and target service data.

It may be understood that, in the embodiment of the disclosure, indication contents corresponding to the first semantic information and the second semantic information may be flexibly configured according to an application scenario, which is not limited herein.

Optionally, in some embodiments, the first semantic information is semantic information of a geographic area dimension. The second semantic information is semantic information of a statistical frequency dimension related to the candidate description object, and/or semantic information of a statistical time dimension related to the candidate description object. Therefore, the first semantic information may provide an accurate screening basis for screening the target description object at the geographic region dimension, and the second semantic information may provide an accurate value range for a selection process of the target service data at the statistical frequency dimension and/or the statistical time dimension.

In the embodiments of the disclosure, when the second semantic information is the semantic information of the statistical frequency dimension related to the candidate description object, service data of other useless statistical frequencies may be filtered out according to the second semantic information, so that an accuracy of the obtained target service data is improved, and the user experience is optimized.

For example, in the embodiments of the disclosure, the first semantic information and the second semantic information corresponding to the query sentence may be recognized based on a large model. When the first semantic information is the semantic information of the geographic area dimension, as shown in FIG. 1a, FIG. 1a is a schematic diagram of recognition of the first semantic information corresponding to the query sentence based on the large model according to the disclosure. The first semantic information may include an administrative region level (such as “country”, “provincial administrative region”, “prefecture-level administrative region”, “county-level administrative region”, “township-level administrative region”, etc.) and a region scope (for example, a partial region corresponding to a regional granularity, or a region list corresponding to the regional granularity). When the query sentence does not relate to a geographic area granularity or a geographic area range, a corresponding content in the first semantic information is empty, which may be described as follows:

(1) the administrative region level: [“country”, “provincial administrative region”, “prefecture-level administrative region”, “county-level administrative region”, “township-level administrative region”, null], where null represents that a geographic location is not explicitly mentioned in the query;

(2) the region scope: [null, “all”, [“xxx”]], where null represents that no specific region is mentioned; “all” represents that all regions of the administrative region level are mentioned; [“xxx”] is a list of specific regions.

When the first semantic information is recognized and answered, some examples are shown as follows.

Query: in December 2022, which country has the largest number of members of Institute A? Answer: {“administrative region level”: “country”, “scope”: “all”}

Query: How did average sale prices of second-hand houses in city a and city b change this year? Answer: {“administrative region level”: “prefecture-level administrative region”, “scope”: [“city a”, “city b”]}

The first semantic information may be knowledge, and is added to a prompt of the large model as a knowledge enhancement.

In the embodiments of the disclosure, when the knowledge enhancement is performed based on the first semantic information, the knowledge enhancement may be respectively performed from dimensions of “administrative region level” and “region scope”, so as to effectively avoid situations of missing recall or incorrect recall of service data with the geographical location in a final recall.

In the embodiments of the disclosure, the semantic information of the statistical frequency dimension may include, for example, year, season, month, ten-day, week, day, and the like.

For a same index of a recall, it may have multiple statistical frequencies, for example, [“the number of stock transactions: Science and Technology Innovation Board: Institute A: current value: year”, “the number of stock transactions: Science and Technology Innovation Board: Institute A: current value: month”, “the number of stock transactions: Science and Technology Innovation Board: Institute A: current value: week”, “the number of stock transactions: Science and Technology Innovation Board: Institute A: current value: day”], and when the query is: “What is the number of stock transactions of Science and Technology Innovation Board of Institute A on Jul. 1, 2021?”, in this case, an index of a day frequency needs to be taken, i.e., “the number of stock transactions: Science and Technology Innovation Board: Institute A: current value: day”, instead of indexes of other statistical frequencies.

In the embodiments of the disclosure, a large model may be used to splice an input query to a specific prompt to complete an analysis of the statistical frequency, and the statistical frequency in the query may be classified into one of seven categories: year, season, month, ten-day, week, day, or null.

### [Few-Shot Example]

1. query: What is annual gross domestic product (GDP) in 2022? statistical frequency: year;

2. query: What is surveyed urban unemployment rate nationwide in Q2 of 2022? statistical frequency: season;

3. query: What is accumulated year-on-year ratio in investment of real estate development nationwide in the last month of 2019? statistical frequency: month.

After a classification is completed, for all recalled indexes, further filtering may be performed, for example, if the statistical frequency of the query is determined as “day”, but the statistical frequency of a certain recalled index is “year”, then this index is filtered out. If the statistical frequency of the query is determined as “null”, then all the statistical frequencies can be accepted, and all the recalled indexes will be reserved.

In the embodiment of the disclosure, a date mentioned in the query is a date in a natural language queried by the user. For example, such a query may be “How is the net profit performance of Company B in the latest Q?” In a database, data recorded in an index “net profit of B company: current value: season” is net profit data from “2005 Sep. 30” to “2023 Sep. 30”. A statistical range recognition in the disclosure is to map the “latest Q” to “2023 Jul. 1” to “2023 Sep. 30” and obtain net profit data generated during a third season from an index library.

The specific implementation will be described as follows.

1) When date portion with a dynamic change is included in the prompt, for example, a relative value of the week, a relative value of the year, the date current_date of a current system is calculated, and then a corresponding start date is found through a date backtracking function.

2) When the few-shot is added to the prompt, for example: Q3 in 2007 refers to: Jul. 1, 2007 to Sep. 30, 2007; and a beginning of 2022 to an end of 2022 refers to: Jan. 1, 2022 to Dec. 31, 2022 . . .

3) When the above dynamic few-shot and query are combined as input and sent to the large model for reasoning, a reasoning result of a date range can be obtained.

4) A start date and an end date are extracted by using a regular expression to the reasoning result and are respectively structured into a format of xxxx-XX-XX.

5) Index values within a corresponding date range can be matched from an index database by using the formatted date range.

At step S103, the at least one candidate description object and the first semantic information are input into the large model to recognize the target description object from the at least one candidate description object based on the large model.

The target description object refers to a description object applicable to the query sentence determined based on the large model.

For example, in the embodiments of the disclosure, the at least one candidate description object and the first semantic information may be input into the large model to obtain at least one reference description object output by the large model. If the at least one candidate description object includes a reference description object, the reference description object is used as the target description object. Therefore, an accuracy of the obtained target description object is effectively ensured.

At step S104, the target service data is selected from at least one piece of service data corresponding to the target description object according to the second semantic information.

The target service data refers to service data obtained after multiple pieces of service data of the target description object are screened according to the second semantic information.

It may be understood that the target description object may have service data of different dimensions, and the query sentence may specify data of a corresponding dimension to be obtained. Therefore, in the embodiments of the disclosure, the target service data may be selected from the at least one piece of service data corresponding to the target description object according to the second semantic information, which effectively reduces redundant data in the obtained target service data.

In the embodiments of the disclosure, when selecting the target service data from the at least one piece of service data corresponding to the target description object according to the second semantic information, corresponding target data may be accurately obtained from the statistical frequency dimension and the statistical time dimension.

At step S105, a reply sentence corresponding to the query sentence is generated according to the target service data.

The reply sentence refers to a sentence used to reply to a content queried in the query sentence.

In the embodiments of the disclosure, when generating the reply sentence corresponding to the query sentence according to the target service data, the target service data may be converted into a data format (for example, a markdown format) suitable for the large model, and then input into the large model to obtain a corresponding reply sentence.

In the embodiments of the disclosure, a query sentence is obtained, in which the query sentence has at least one corresponding candidate description object; semantic recognition is performed on the query sentence to obtain first semantic information and second semantic information corresponding to the query sentence, in which categories of the first semantic information and the second semantic information are different; the at least one candidate description object and the first semantic information are input into the large model, to identify a target description object from the at least one candidate description object based on the large model; target service data is selected from at least one piece of service data corresponding to the target description object based on the second semantic information; and a reply sentence corresponding to the query sentence is generated according to the target service data, so that different types of semantic information of the query sentence can be identified, the target description object can be identified from the at least one candidate description object based on the first semantic information and the large model, the target service data is selected from the at least one piece of service data corresponding to the target description object based on the second semantic information, and the reply sentence is generated based on the target service data. In this way, adaptability of the obtained reply sentence and the query sentence is improved effectively, thereby improving the reply effect.

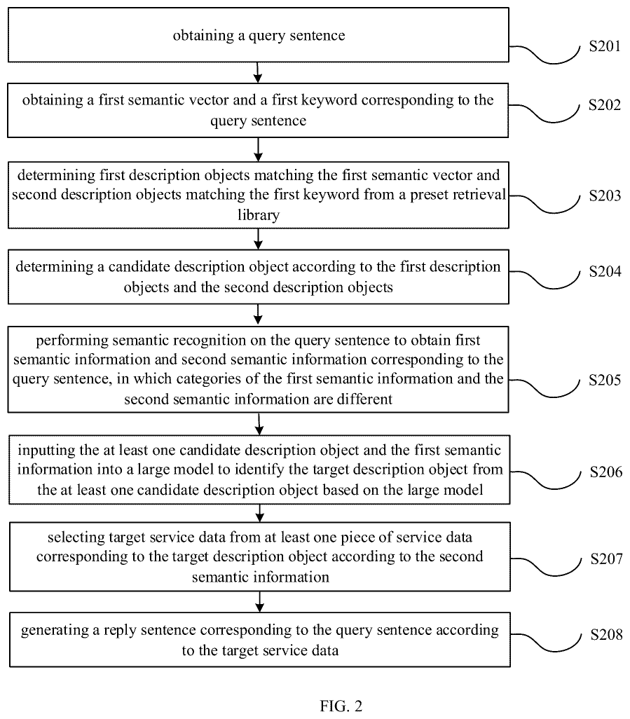

FIG. 2 is a schematic flowchart illustrating a sentence generation method according to another embodiment of the disclosure.

As shown in FIG. 2, the sentence generation method includes the following steps.

At step S201, a query sentence is obtained.

For details of description of S201, reference may be made to the foregoing embodiment, which will not be repeated here.

At step S202, a first semantic vector and a first keyword corresponding to the query sentence are obtained.

The first semantic vector refers to a vector obtained by performing semantic vectorization processing on the query sentence.

The first keyword refers to a keyword obtained after keyword extraction is performed on the query sentence. For example, in the embodiments of the disclosure, the query sentence may be segmented to determine candidate words, then word frequencies of the candidate words are determined. A candidate word corresponding to a highest word frequency value is used as the first keyword, or the first keyword may be determined based on any possible method, which is not limited herein.

Optionally, in some embodiments, when obtaining the first semantic vector corresponding to the query sentence, vectorization processing may be performed on the query sentence based on a monolingual semantic vector model to obtain the first semantic vector, and/or vectorization processing may be performed on the query sentence based on a multilingual semantic vector model to obtain the first semantic vector. Therefore, the monolingual semantic vector model and/or the multilingual semantic vector model can be flexibly used for vectorization processing in the vectorization processing process of the query sentence, so that the obtaining process of the first semantic vector is suitable for text language scene in which the query sentence is personalized to ensure an indication effect of the obtained first semantic vector.

A semantic vector model relates to the NLP technology, and mainly maps words or phrases into a high-dimensional vector space to implement semantic understanding and processing of a text.

The monolingual semantic vector model may be a semantic vectorization model for vectorizing monolingual texts, for example, may be a semantic vector model configured for a specific language type such as Chinese or English.

The multilingual semantic vector model may be a semantic vectorization model for vectorizing multilingual mixed texts, for example, may be a semantic vector model configured for mixed language texts including languages such as Chinese and English.

In the embodiments of the disclosure, the number of monolingual semantic vector models and the number of multilingual semantic vector models may be flexibly configured according to an application scenario, so as to obtain different numbers of first semantic vectors to adapt to personalized application scenarios.

It may be understood that corpus, model structures, and the like of different independent pre-trained models may be different. For a dense vector of a 1024-dimensional large model or a dense vector of the 768-dimensional base model, different models may have differences in a semantic space. Therefore, different models may be adopted in the disclosure, which improves a recall rate from different semantic directions. When the multilingual semantic vectorization model is adopted, for a Chinese-English mixed index, such as “CPI: [symbol] : [symbol] : [symbol] ”, “PPIRM: [symbol] : [symbol] : [symbol] ”, the recall rate can be increased.

For example, in the embodiments of the disclosure, multiple independent embedding models may be used to perform multi-way vectorizations on the query sentence.

At step S203, first description objects matching the first semantic vector and second description objects matching the first keyword are determined from a preset retrieval library.

The preset retrieval library may be a pre-configured retrieval library in which the first semantic vector and the first keyword are retrieved.

The first description objects may refer to description objects obtained after performing vectorization retrieval based on the first semantic vector and the preset retrieval library. The second description objects may refer to description objects obtained after performing keyword retrieval based on the first keyword and the preset retrieval library. For example, an ElsticSearch (ES) retrieval library may be constructed as the preset retrieval library, and service description objects with the highest recall score are determined as the second description objects based on term retrieval of the ES retrieval library.

That is, in the embodiments of the disclosure, the first description objects and the second description objects may be determined from the preset retrieval library based on the vectorization retrieval and the keyword retrieval respectively, so as to provide a reliable data support for subsequently determining a candidate description object.

It may be understood that description objects obtained based on a single way may have a large error. In the embodiments of the disclosure, the first description objects matching the first semantic vector and the second description objects matching the first keyword are respectively determined from the preset retrieval library, so that robustness of a determination process of the candidate description object can be effectively improved.

Optionally, in some embodiments, a service database may be obtained, the service database includes multiple pieces of initial service data. Service description objects of the initial service data, and data record types and data recording frequencies corresponding to the service description objects are determined. The multiple pieces of initial service data are aggregated based on the service description objects, the data record types and the data record frequencies to obtain aggregated service data. The aggregated service data includes at least one piece of service data corresponding to a target description object. The service description objects are vectorized based on the semantic vector model to obtain a second semantic vector. Based on the aggregated service data and the second semantic vector, the preset retrieval library is constructed, so that a reliable service data support may be provided, based on the service database, for a generation process of a reply sentence. The service database may include different service description objects, and each service description object may also have service data with different data record types and data recording frequencies, so that there may be so many redundant data. Therefore, the multiple pieces of initial service data may be aggregated based on the service description objects, the data record types and the data recording frequencies, to effectively reduce redundant data in the obtained preset retrieval library and improve a retrieval efficiency.

The service database may be a database containing various service data corresponding to the service description objects, for example, may be a financial data index library, such as an index library (Hermes Index) of Hundsun Ju Yuan company.

For example, in the embodiment of the disclosure, when constructing the preset retrieval library, it may be based on the following steps:

(1) aggregating core indexes (i.e., the above service description objects)
for index data “the number of imports of automobiles and automobile chassis: accumulated value: month”, “the number of imports of automobiles and automobile chassis” is a core index, and cleaning, deduplication and aggregation can be performed on the core index.

(2) aggregating statistics manners (i.e., the above data record types)
common statistical manners include current value, accumulated value, current year-on-year ratio, accumulated year-on-year ratio, month-on-month ratio, month-on-month ratio growth or reduction, and the like.

For index data “the number of imports of automobiles and automobile chassis: accumulated value: month” and “the number of imports of automobiles and automobile chassis: current value: month”, “accumulated value” and “current value” indicate the statistical manners. The above statistical manners may be aggregated into a “statistical manner” field.

(3) aggregating statistical frequencies (i.e., the above data recording frequencies)
common statistical frequencies include year, season, month, ten-day, week, and day.

For index data “the number of inlets of automobiles and automobile chassis: accumulated value: day” and “the number of inlets of automobiles and automobile chassis: accumulated value: month”, “day” and “month” indicate the statistical frequencies. The above statistical frequencies may be aggregated into a “statistical frequency” field.

(4) embedding to construct an index ES retrieval library (i.e., the above preset retrieval library)
for an index library obtained through aggregations of steps (1) to (3), fields such as an index ID, a core index, a statistical manner, a statistical frequency, and index data are provided. Seven independent embedding models can be used to perform multi-way vectorization on the core index, which includes a total of six Chinese vectorization models and one multilingual vectorization model, vectorization of Chinese indexes and Chinese-English mixed indexes are considered, and then the ES retrieval library is constructed.

The purpose of aggregation in the foregoing steps is to distinguish the core index, the statistical manner and the statistical frequency. For one query, the core index is recalled by using a vector and a keyword, and the statistical manner and the statistical frequency are recalled through an intention recognition. On one hand, a number of core indexes can be reduced, and a system retrieval efficiency is higher. On the other hand, the statistical manner and the statistical frequency are relatively fixed and can be enumerated, so that they are stripped from indexes, and intention judgment is performed on them by using a proprietary model, which improves an accuracy of overall index question answering. For the index question answering, the above split retrieval manner is superior to overall retrieval manner. Compared with a method for mining indexes by using materials such as research reports, an existing professional financial index database can be directly used in the disclosure, which greatly improves the richness and accuracy of data.

Optionally, in some embodiments, when performing vectorization processing on the service description objects based on the semantic vector model to obtain the second semantic vector, the vectorization processing is performed on the service description objects based on the monolingual semantic vector model to obtain the second semantic vector, and/or the vectorization processing is performed on the service description objects based on the multilingual semantic vector model to obtain the second semantic vector. Therefore, the monolingual semantic vector model and/or the multilingual semantic vector model may be flexibly used for the vectorization processing in the vectorization processing process of the service description objects, to ensure that the vectorization processing process is adapted to the service description objects of different language types, and to ensure that the obtained second semantic vector has an indication effect for the service description objects.

It may be understood that, in the embodiment of the disclosure, the vectorization processing may be performed on the service description objects based on one or more semantic vector models, to obtain one or more second semantic vectors, which is not limited herein.

At step S204, the candidate description object is determined according to the first description objects and the second description objects.

In the embodiments of the disclosure, when the candidate description object is determined according to the first description objects and the second description objects, the candidate description object may be determined from the first description objects and the second description objects based on a third-party description object determining device, or the candidate description object may be determined based on any other possible method according to the first description objects and the second description objects, which is not limited herein.

That is, in the embodiments of the disclosure, the first semantic vector and the first keyword corresponding to the query sentence can be obtained, the first description objects matching the first semantic vector and the second description objects matching the first keyword are determined from the preset retrieval library, and the candidate description object is determined according to the first description objects and the second description objects. Therefore, the first description objects can be obtained after performing the vectorization retrieval in the preset retrieval library based on the first semantic vector, and the second description objects can be obtained after performing keyword retrieval in the preset retrieval library based on the first keyword. Since the first description objects and the second description objects are obtained based on different retrieval logics, when the first description objects and the second description objects are combined to determine the candidate description object, it can effectively reduce an error impact caused by a single retrieval logic and ensure reliability of the obtained candidate description object.

Optionally, in some embodiments, when the candidate description object is determined according to the first description objects and the second description objects, first score values of the first description objects and second score values of the second description objects may be determined based on a preset scoring model. A first score value is used to describe a matching degree between a corresponding first description object and the query sentence, and a second score value is used to describe a matching degree between a corresponding second description object and the query sentence. The first description objects and the second description objects are ranked according to the first score values and the second score values, and a third number of first description objects and/or the second description objects ranked in the front are used as the candidate description objects. Since the first description objects and the second description objects are obtained based on different retrieval logics, initial score values corresponding to the first description objects and the second description objects cannot be directly used for ranking comparison. Therefore, when the first score values of the first description objects and the second score values of the second description objects are determined based on the preset scoring model, re-scoring of the first description objects and the second description objects may be implemented, so that reference information is provided for a ranking process of the first description objects and the second description objects, and the third number of first description objects and/or the second description objects ranked in the front are taken as the candidate description objects to ensure the accuracy of the obtained candidate description objects.

The preset scoring model refers to a pre-trained model for re-scoring the first description objects and the second description objects. For example, a bge-rank-base model may be used as the preset scoring model for re-scoring.

Optionally, in some embodiments, sample data may be obtained. The sample data includes: a sample query sentence and multiple sample replay sentences corresponding to the sample query sentence. A service scenario corresponding to the query sentence is determined, and the multiple sample replay sentences are labeled according to the service scenario to determine positive sample reply sentences and negative sample reply sentences from the multiple sample reply sentences. The initial scoring model is trained based on the sample query sentence, the positive sample reply sentences and the negative sample reply sentences to obtain the preset scoring model. Therefore, the sample reply sentences can be labeled in combination with the service scenario corresponding to the query sentence, so that the adaptability of obtained model training data and the service scenario corresponding to the query sentence is ensured. Then the initial scoring model is trained based on the sample query sentence, the positive sample reply sentences and the negative sample reply sentences, so that an accuracy of the matching degree between the description object and the query sentence indicated by a score value output by the obtained preset scoring model can be effectively improved.

In the disclosure, when the sample reply sentences are labeled according to the service scenario, if the service scenario is a macroscopic economic analysis scenario, macroscopic indexes may be selected to be labeled positive (pos) samples. If the service scenario is a financial analysis scenario, indexes such as company financial, income, profit, and liability and the like may be selected to be the labeled pos samples. If the service scenario is a market analysis scenario, various indexes on stock market, such as stock price, trading volume, price-earnings ratio, and the like which are used for analyzing a market trend and estimation may be selected to be the labeled pos samples. If the service scenario is a risk analysis scenario, indexes capable to measure an investment risk, such as a fluctuation rate, a beta coefficient, and the like, which may help investors evaluate a risk level of an investment portfolio, may be selected to be the labeled pos samples.

For example, in the embodiments of the disclosure, training and reasoning flow of the preset scoring model includes the following steps:
1) converting a query (i.e., the above sample query sentence) and a candidate index list (i.e., the multiple sample reply sentences) into a text pair of a query and an index list: “query ||| index”, and then a label is determined as 1 or 0;
2) labeling pos as 1 and neg as 0 by using a doccano labeling tool;
3) constructing a target data structure according to labeled results, in which the target data structure is composed of a query, a pos index, and a neg index;
4) adjusting learning parameters, performing fine-tuning on a pre-trained model by using data in the target data structure, evaluating and publishing a reasoning model, and encapsulating a reasoning service by using a python FastAPI framework; and
5) deploying them to a server, loading a model, and using GPU reasoning. In online use, for one query and multiple input recall indexes, a score of the query for each recall index may be given.

At step S205, semantic recognition is performed on the query sentence to obtain first semantic information and second semantic information corresponding to the query sentence, in which categories of the first semantic information and the second semantic information are different.

At step S206, the at least one candidate description object and the first semantic information are input into a large model to identify the target description object from the at least one candidate description object based on the large model.

At step S207, target service data is selected from at least one piece of service data corresponding to the target description object according to the second semantic information.

At step S208, a reply sentence corresponding to the query sentence is generated according to the target service data.

For details of description of S205-S208, reference may be made to the foregoing embodiment, which will not be repeated here.

In the embodiment of the disclosure, a query sentence is obtained; a first semantic vector and a first keyword corresponding to the query sentence are obtained; first description objects matching the first semantic vector and second description objects matching the first keyword are determined from a preset retrieval library; a candidate description object is determined from the preset retrieval library based on the first description objects and the second description objects; semantic recognition is performed on the query sentence to obtain first semantic information and second semantic information corresponding to the query sentence, in which categories of the first semantic information and the second semantic information are different; at least one candidate description object and the first semantic information are input into a large model to identify the target description object from the at least one candidate description object based on the large model; target service data is selected from at least one piece of service data corresponding to the target description object according to the second semantic information; and a reply sentence corresponding to the query sentence is generated according to the target service data. Therefore, the first description objects can be obtained after performing the vectorization retrieval in the preset retrieval library based on the first semantic vector, and the second description objects can be obtained after performing keyword retrieval in the preset retrieval library based on the first keyword. Since the first description objects and the second description objects are obtained based on different retrieval logics, when the first description objects and the second description objects are combined to determine the candidate description object, it can effectively reduce the error impact caused by the single retrieval logic and ensure the reliability of the obtained candidate description object.

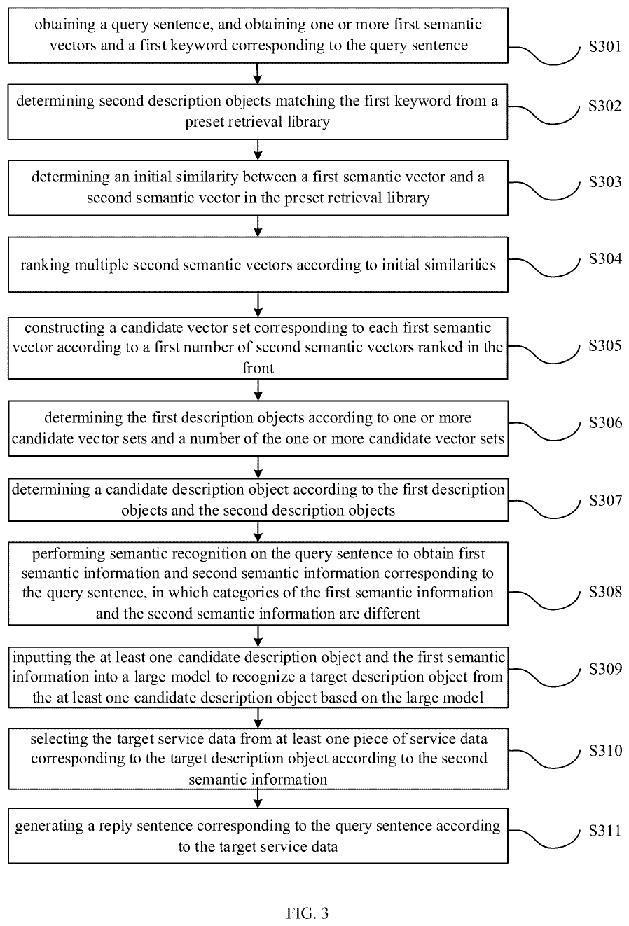

FIG. 3 is a schematic flowchart illustrating a sentence generation method according to another embodiment of the disclosure.

As shown in FIG. 3, the sentence generation method includes the following steps.

At step S301, a query sentence is obtained, and one or more first semantic vectors and a first keyword corresponding to the query sentence are obtained.

At step S302, second description objects matching the first keyword are determined from a preset retrieval library.

For details of description of S301 and S302, reference may be made to the foregoing embodiment, which will not be repeated here.

At step S303, an initial similarity between a first semantic vector and a second semantic vector in the preset retrieval library is determined.

The initial similarity refers to a similarity between the first semantic vector and the second semantic vector.

It may be understood that a similarity between semantic vectors is generally positively correlated with a similarity between corresponding sentence description objects, so that when the initial similarity between the first semantic vector and the second semantic vector in the preset retrieval library is determined, reliable reference information may be provided for a vectorization retrieval process of the first semantic vector.

At step S304, multiple second semantic vectors are ranked according to initial similarities.

That is, in this embodiment of the disclosure, after determining the initial similarity between the first semantic vector and the second semantic vector in the preset retrieval library, the plurality of second semantic vectors may be ranked from high to low based on the initial similarities, so as to determine a second semantic vector having a higher similarity with the first semantic vector.

At step S305, a candidate vector set corresponding to each first semantic vector is constructed according to a first number of second semantic vectors ranked in the front.

The candidate vector set refers to a vector set constructed by the first number of the second semantic vectors ranked in the front based on the initial similarities.

In the embodiments of the disclosure, when constructing the candidate vector set corresponding to the first semantic vector according to the first number of the second semantic vectors ranked in the front, reliable candidate objects may be provided for a determination process of first description objects.

At step S306, the first description objects are determined according to the candidate vector set corresponding to each first semantic vector and a number of candidate vector sets.

It may be understood that in the embodiments of the disclosure, the query sentence may be vectorized based on one or more semantic vector models to obtain one or more first semantic vectors. Therefore, the number of the candidate vector sets may also be one or more, and different numbers of the candidate vector sets may affect the determination process of the first description objects, so that the first description objects need to be determined in combination with the one or more candidate vector sets and the number of the candidate vector sets.

That is to say, in the embodiments of the disclosure, after the one or more first semantic vectors corresponding to the query sentence are obtained, the initial similarity between the first semantic vector and the second semantic vector in the preset retrieval library can be determined. The multiple second semantic vectors are ranked according to the initial similarities. A candidate vector set corresponding to the first semantic vector is constructed according to the first number of second semantic vectors ranked in the front. The first description objects are determined according to the candidate vector sets and the number of the candidate vector sets. Therefore, the initial similarity between the first semantic vector and the second semantic vector in the preset retrieval library can be determined. The multiple second semantic vectors are ranked according to the initial similarities, and the candidate vector set corresponding to the first semantic vector is constructed according to the first number of second semantic vectors ranked in the front, so as to realize rough screening of the plurality of second semantic vectors in the preset retrieval library based on the ranking of initial similarities. Then, in combination with one or more candidate vector sets and the number of the one or more candidate vector sets, a corresponding recognition method is flexibly used to determine the first description objects from a plurality of service description objects, which can effectively improve adaptability of the first description objects and the query sentence.

Optionally, in some embodiments, the number of the one or more candidate vector sets is one. When determining the first description objects according to the one or more candidate vector sets and the number of the one or more candidate vector sets, weighting is performed on the initial similarity of a second semantic vector according to a corresponding ranking order of the second semantic vector in the candidate vector set, to obtain a target similarity corresponding to the second semantic vector. The first description objects are determined according to the target similarity of each second semantic vector. Therefore, when the number of the one or more candidate vector sets is one, the initial similarity can be adjusted by combining the ranking order of the second semantic vector in the candidate vector set, to effectively improve an indication accuracy of the obtained target similarity, and so as to determine reliable first description objects according to the target similarity.

For example, when weighting the initial similarity of the second semantic vector according to the corresponding ranking order of the second semantic vector in the candidate vector set, a corresponding weighting value is determined according to the ranking order of the second semantic vector in the candidate vector set. When the ranking order of the second semantic vector is higher, the corresponding weighting value is larger, and then a product value of the weighting value and the initial similarity is calculated as the target similarity. For example, when the ranking order is N, the corresponding weighting value can be 1/N.

Optionally, in some embodiments, the number of the one or more candidate vector sets is more than one, and different candidate vector sets are obtained by vectorizing the query sentence based on different semantic vector models. When determining the first description objects according to the one or more candidate vector sets and the number of the one or more candidate vector sets, weighting is performed the initial similarity of the second semantic vector according to the corresponding ranking order of the second semantic vector in the candidate vector set, so as to obtain a reference similarity corresponding to the second semantic vector. A sum of a plurality of reference similarities corresponding to the second semantic vector is determined as the target similarity. The first description objects are determined according to the target similarity of each second semantic vector. Therefore, when the number of the one or more candidate vector sets is more than one, the initial similarity can be adjusted by combining the ranking order of the second semantic vector in the candidate vector set to obtain the reference similarity. Then, the sum of the plurality of reference similarities corresponding to the second semantic vector is determined as the target similarity, so as to realize a deduplication of the second semantic vector in multiple candidate vector sets and ensure the indication effect of the obtained target similarity, so as to accurately recognize the first description objects based on the target similarity.

It may be understood that a same second semantic vector may have relatively high reference similarities with a plurality of first semantic vectors at the same time. In this case, the sum of the plurality of reference similarities corresponding to the second semantic vector is determined as the target similarity, so that the deduplication of the second semantic vector in the multiple candidate vector sets may be implemented.

Optionally, in some embodiments, the preset retrieval library includes aggregated service data. The aggregated service data contains a plurality of service description objects. The service description objects are associated with the second semantic vector. When determining the first description objects according to the target similarity, multiple second semantic vectors can be ranked according to the target similarities. The service description objects corresponding to a second number of second semantic vectors ranked in the front are determined as the first description objects. Therefore, the multiple second semantic vectors can be ranked according to the target similarities to determine a size relationship of the target similarities corresponding to the multiple second semantic vectors. Then, the service description objects corresponding to the second number of second semantic vectors ranked in the front are selected as the first description objects, so as to screen out the second number of second semantic vectors with higher target similarities, and take the corresponding service description objects as the first description objects to ensure the adaptability of the first description objects.

At step S307, a candidate description object is determined according to the first description objects and the second description objects.

At step S308, semantic recognition is performed on the query sentence to obtain first semantic information and second semantic information corresponding to the query sentence, in which categories of the first semantic information and the second semantic information are different.

At step S309, the at least one candidate description object and the first semantic information are input into a large model to recognize a target description object from the at least one candidate description object based on the large model.

At step S310, the target service data is selected from at least one piece of service data corresponding to the target description object according to the second semantic information.

At step S311, a reply sentence corresponding to the query sentence is generated according to the target service data.

For details of description of S307-S311, reference may be made to the foregoing embodiment, which will not be repeated here.

In the embodiments of the disclosure, a query sentence is obtained, and one or more first semantic vectors and a first keyword corresponding to the query sentence are obtained. Second description objects matching the first keyword are determined from a preset retrieval library. An initial similarity between the first semantic vector and a second semantic vector in the preset retrieval library is determined. Multiple second semantic vectors are ranked according to the initial similarities. A candidate vector set corresponding to the first semantic vector is constructed according to a first number of second semantic vectors ranked in the front. First description objects are determined according to one or more candidate vector sets and a number of the one or more candidate vector sets. A candidate description object is determined according to the first description objects and the second description objects. Semantic recognition is performed on the query sentence to obtain first semantic information and second semantic information corresponding to the query sentence, in which categories of the first semantic information and the second semantic information are different. The at least one candidate description object and the first semantic information are input into a large model to recognize a target description object from the at least one candidate description object based on the large model. Target service data is selected from at least one piece of service data corresponding to the target description object according to the second semantic information. A reply sentence corresponding to the query sentence is generated according to the target service data. Therefore, the initial similarity between the first semantic vector and the second semantic vector in the preset retrieval library can be determined. The multiple second semantic vectors are ranked according to the initial similarities, and the candidate vector set corresponding to the first semantic vector is constructed according to the first number of second semantic vectors ranked in the front, so as to realize rough screening of the plurality of second semantic vectors in the preset retrieval library based on the ranking of initial similarities. Then, in combination with one or more candidate vector sets and the number of the one or more candidate vector sets, a corresponding recognition method is flexibly used to determine the first description objects from a plurality of service description objects, which can effectively improve adaptability of the first description objects and the query sentence.

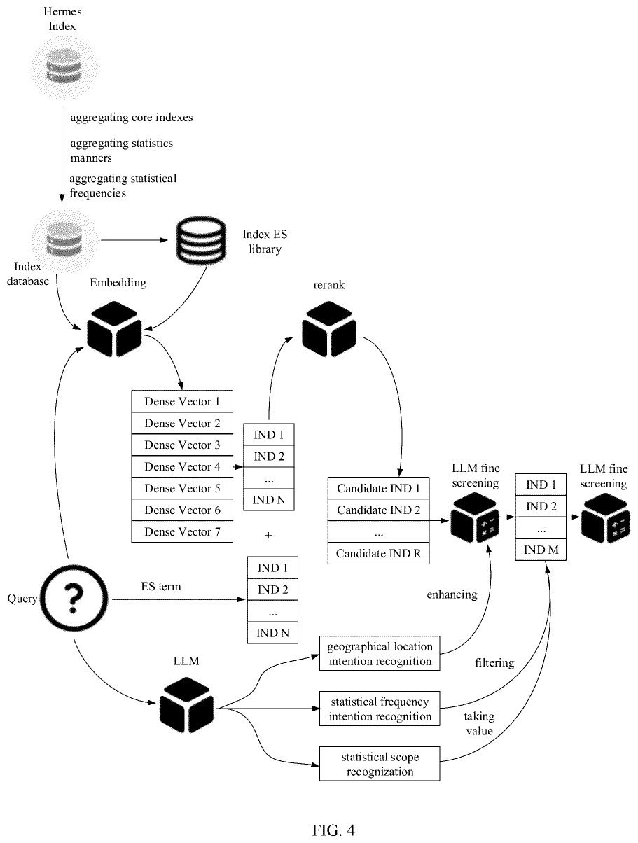

For example, when the disclosure is applied to an index question answering scenario of intelligent investment research, as shown in FIG. 4, FIG. 4 is a flowchart illustrating an index question answering algorithm for the intelligent investment research according to the disclosure, which includes two large modules: offline index storage and online index question answering. Processing logic in the diagram can be seen in the technical solution of the above implementation example, which is not repeated here.

FIG. 5 is a block diagram of a sentence generation apparatus according to an embodiment of the disclosure.

As shown in FIG. 5, the sentence generation apparatus 50 includes:
an obtaining module 501, configured to obtain a query sentence, the query sentence has at least one candidate description object;
a first recognizing module 502, configured to perform semantic recognition on the query sentence to obtain first semantic information and second semantic information corresponding to the query sentence, categories of the first semantic information and the second semantic information are different;
a second recognizing module 503, configured to input the at least one candidate description object and the first semantic information into a large model to recognize a target description object from the at least one candidate description object based on the large model;
a third recognizing module 504, configured to select target service data from at least one piece of service data corresponding to the target description object based on the second semantic information; and
a generating module 505, configured to generate a reply sentence corresponding to the query sentence according target service data.

In some embodiments of the disclosure, the first semantic information is semantic information of a geographic area dimension; and the second semantic information is semantic information of a statistical frequency dimension related to the candidate description object, and/or semantic information of a statistical time dimension related to the candidate description object.

In some embodiments of the present disclosure, the obtaining module 501 is further configured to:
obtain one or more first semantic vectors and a first keyword corresponding to the query sentence;
determine first description objects matching the one or more first semantic vectors and second description objects matching the first keyword from a preset retrieval library; and
determine a candidate description object according to the first description objects and the second description objects.

In some embodiments of the present disclosure, the obtaining module 501 is further configured to:
obtain a service database, in which the service database includes multiple pieces of initial service data;
determine service description objects of initial service data, and data record types and data record frequencies corresponding to the service description objects;
perform aggregation processing on the multiple pieces of initial service data based on the service description objects, the data record types, and the data recording frequencies, to obtain aggregated service data, in which the aggregated service data includes the at least one piece of service data corresponding to target description object;
perform vectorization processing on service description objects based on a semantic vector model, to obtain a second semantic vector; and
construct the preset retrieval library based on the aggregated service data and the second semantic vector.

In some embodiments of the present disclosure, the obtaining module 501 is further configured to:
perform the vectorization processing on the service description objects based on a monolingual semantic vector model, to obtain the second semantic vector; and/or
perform the vectorization processing on the service description objects based on a multilingual semantic vector model, to obtain the second semantic vector.

In some embodiments of the present disclosure, the obtaining module 501 is further configured to:
perform the vectorization processing on the query sentence based on a monolingual semantic vector model, to obtain a first semantic vector; and/or perform the vectorization processing on the query sentence based on a multi lingual semantic vector model, to obtain a first semantic vector.

In some embodiments of the present disclosure, the preset retrieval library includes multiple second semantic vectors, the obtaining module 501 is further configured to:
determine an initial similarity between the a semantic vector and each second semantic vector in the preset retrieval library;
ranking a plurality of second semantic vectors according to initial similarities;
constructing a candidate vector set corresponding to the first semantic vector according to a first number of second semantic vectors ranked in the front; and
determining the first description objects according to one or more candidate vector sets and a number of the one or more candidate vector sets.

In some embodiments of the disclosure, the number of the candidate description object is one, the obtaining module 501 is further configured to:
perform weighting processing on the initial similarity of each second semantic vector according to a ranking order of the second semantic vector in the candidate vector set to obtain a target similarity corresponding to the second semantic vector; and
determine first description objects according to the target similarity of each second semantic vector.

In some embodiments of the disclosure, the number of the candidate description object is multiple, and different candidate vector sets are obtained by vectorizing the query sentence based on different semantic vector models; the obtaining module 501 is further configured to:
perform weighting processing on the initial similarity of each second semantic vector according to the corresponding ranking order of the second semantic vector in each candidate vector set, to obtain the reference similarity corresponding to the second semantic vector;
determine a sum of multiple reference similarities corresponding to the second semantic vector as a target similarity of the second semantic vector; and
determine first description objects according to the target similarity of each second semantic vector.

In some embodiments of the disclosure, the preset retrieval library includes aggregated service data, the aggregated service data includes multiple service description objects, and the service description objects are associated with the second semantic vectors; the obtaining module 501 is further configured to:
rank the multiple second semantic vectors according to the target similarity of each second semantic vector; and
take the service description objects corresponding to a second number of second semantic vectors ranked in the front as the first description objects.

In some embodiments of the disclosure, the obtaining module 501 is further configured to:
determine a first score value of each first description object and a second score value of each second description object based on a preset scoring model, in which the first score value is used to describe a matching degree corresponding to the first description object and the query sentence, and the second score value is used to describe a matching degree corresponding to the second description object and the query sentence; and
rank the first description objects and the second description objects according to the first score value of each first description object and the second score value of each second description object; and
determine a third number of first description objects and/or second description objects ranked in the front as candidate description objects.

In some embodiments of the disclosure, the obtaining module 501 is further configured to:
obtain sample data, in which, the sample data includes: a sample query sentence and multiple sample replay sentences corresponding to the sample query sentence;
determine a service scenario corresponding to the query sentence;

label the multiple sample replay sentences according to the service scenario to determine positive sample reply sentences and negative sample reply sentences from the multiple sample reply sentences; and
train an initial scoring model based on the sample query sentence, the positive sample reply sentences and the negative sample reply sentences to obtain the preset scoring model.

It needs to be noted that the foregoing explanation of the embodiment of the sentence generation method is also applied to the sentence generation apparatus in the embodiment, which is not repeated here.

In the embodiments of the disclosure, a query sentence is obtained, in which the query sentence has at least one corresponding candidate description object; semantic recognition is performed on the query sentence to obtain first semantic information and second semantic information corresponding to the query sentence, in which categories of the first semantic information and the second semantic information are different; the at least one candidate description object and the first semantic information are input into the large model, to identify a target description object from the at least one candidate description object based on the large model; target service data is selected from at least one piece of service data corresponding to the target description object based on the second semantic information; and a reply sentence corresponding to the query sentence is generated according to the target service data, so that different types of semantic information of the query sentence can be identified, the target description object can be identified from the at least one candidate description object based on the first semantic information and the large model, the target service data is selected from the at least one piece of service data corresponding to the target description object based on the second semantic information, and the reply sentence is generated based on the target service data. In this way, adaptability of the obtained reply sentence and the query sentence is improved effectively, thereby improving the reply effect.

In the present disclosure, an electronic device, a readable storage medium and a computer program product are further provided according to embodiments of the present disclosure.

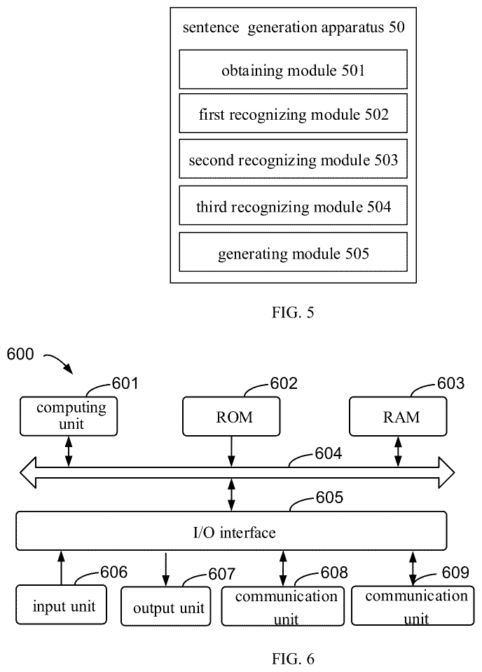

FIG. 6 is a block diagram illustrating an example electronic device 600 in the embodiment of the present disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As shown in FIG. 6, a device 600 includes a computing unit 601, configured to execute various appropriate actions and processes according to a computer program stored in a read-only memory (ROM) 602 or loaded from a memory unit 608 to a random access memory (RAM) 603. In a RAM 603, various programs and data required for a device 600 may be stored. A computing unit 601, a ROM 602 and a RAM 603 may be connected with each other by a bus 604. An input/output (I/O) interface 605 is also connected to a bus 604.

A plurality of components in the device 600 are connected to an I/O interface 605, and includes: an input unit 606, for example, a keyboard, a mouse, etc.; an output unit 607, for example, various types of displays, speakers, etc.; a memory unit 608, for example, a magnetic disk, an optical disk, etc.; and a communication unit 609, for example, a network card, a modem, a wireless transceiver, etc. The communications unit 609 allows a device 600 to exchange information/data through a computer network such as internet and/or various types of telecommunication networks and other devices.

The computing unit 601 may be various types of general and/or dedicated processing components with processing and computing ability. Some examples of the computing unit 601 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 601 executes various methods and processes as described above, for example, a sentence generation method. For example, in some embodiments, the sentence generation method query may be further implemented as a computer software program, which is physically contained in a machine readable medium, such as a memory unit 608. In some embodiments, a part or all of the computer program may be loaded and/or installed on the device 600 through an ROM 602 and/or a communication unit 609. When the computer program is loaded on an RAM 603 and executed by a computing unit 601, one or more blocks in the sentence generation method as described above may be performed. Alternatively, in other embodiments, a computing unit 601 may be configured to execute the sentence generation method in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), a system on a chip (SoC), a load programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of multiple programming languages. These programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be executed completely or partly on the machine, executed partly on the machine as an independent software package and executed partly or completely on the remote machine or server.

In the context of the present disclosure, a machine-readable medium may be a tangible medium that may contain or store a program intended for use in or in conjunction with an instruction execution system, apparatus, or device. A machine-readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relation between the client and the server is generated by computer programs that run on the corresponding computer and have a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

It should be understood that, various forms of procedures shown above may be configured to reorder, add or delete blocks. For example, blocks described in the present disclosure may be executed in parallel, sequentially, or in a different order, as long as the desired result of the technical solution disclosed in the present disclosure may be achieved, which will not be limited herein.

In addition, the terms “first” and “second” used in the present disclosure are only for description purpose, and may not be understood as relative importance of indication or implication or number of technical features indicated by implication. Therefore, features limiting “first” and “second” may explicitly or implicitly include at least one of the features. In the description of the present disclosure, “multiple” means at least two, for example two, three, etc., unless otherwise specified. In the description of the present disclosure, the words “if” as used herein may be interpreted as or “when” or “in response to determination” or “in a case that”.

The above specific implementations do not constitute a limitation on the protection scope of the present disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of embodiments of the present disclosure.

1. A sentence generation method, comprising:
obtaining a query sentence, wherein the query sentence has at least one candidate description object;
performing semantic recognition on the query sentence to obtain first semantic information and second semantic information corresponding to the query sentence, wherein categories of the first semantic information and the second semantic information are different;
inputting the at least one candidate description object and the first semantic information into a large model, to identify a target description object from the at least one candidate description object based on the large model;
selecting target service data from at least one piece of service data corresponding to the target description object based on the second semantic information; and
generating a reply sentence corresponding to the query sentence according to the target service data.

2. The method according to claim 1, wherein the first semantic information is semantic information of a geographic area dimension; and the second semantic information is semantic information of a statistical frequency dimension related to the candidate description object, and/or semantic information of a statistical time dimension related to the candidate description object.

3. The method according to claim 1, wherein the at least one candidate description object is determined based on a following manner:
obtaining one or more first semantic vectors and a first keyword corresponding to the query sentence;
determining first description objects matching the one or more first semantic vectors and second description objects matching the first keyword from a preset retrieval library; and
determining the candidate description object according to the first description objects and the second description objects.

4. The method according to claim 3, wherein the preset retrieval library is constructed based on a following manner:
obtaining a service database, wherein the service database comprises multiple pieces of initial service data;
determining service description objects of the initial service data, and data record types and data record frequencies corresponding to the service description objects;
performing aggregation processing on the multiple pieces of initial service data based on the service description objects, the data record types, and the data recording frequencies, to obtain aggregated service data, wherein the aggregated service data comprises the at least one piece of service data corresponding to the target description object;
performing vectorization processing on the service description objects based on a semantic vector model, to obtain a second semantic vector; and
constructing the preset retrieval library based on the aggregated service data and the second semantic vector.

5. The method according to claim 4, wherein performing the vectorization processing on the service description objects based on the semantic vector model, to obtain the second semantic vector comprises:
performing the vectorization processing on the service description objects based on a monolingual semantic vector model, to obtain the second semantic vector; and/or
performing the vectorization processing on the service description objects based on a multilingual semantic vector model, to obtain the second semantic vector.

6. The method according to claim 3, wherein obtaining the one or more first semantic vectors corresponding to the query sentence comprises:
performing vectorization processing on the query sentence based on a monolingual semantic vector model, to obtain a first semantic vector; and/or
performing the vectorization processing on the query sentence based on a multilingual semantic vector model, to obtain a first semantic vector.

7. The method according to claim 3, wherein the preset retrieval library comprises:
multiple second semantic vectors, wherein determining the first description objects matching the one or more first semantic vectors from the preset retrieval library comprises:
determining an initial similarity between a first semantic vector and each second semantic vector in the preset retrieval library;
ranking the multiple second semantic vectors according to initial similarities;
constructing a candidate vector set corresponding to the first semantic vector according to a first number of second semantic vectors ranked in the front; and
determining the first description objects according to one or more candidate vector sets and a number of the one or more candidate vector sets.

8. The method according to claim 7, wherein there is one candidate vector set, and determining the first description objects according to the one or more candidate vector sets and the number of the one or more candidate vector sets comprises:
performing weighting processing on the initial similarity of each second semantic vector according to a corresponding ranking order of the second semantic vector in the candidate vector set to obtain a target similarity corresponding to the second semantic vector; and
determining the first description objects according to the target similarity of each second semantic vector.

9. The method according to claim 7, wherein there are multiple candidate vector sets, and different candidate vector sets are respectively obtained by performing vectorization processing on the query sentence based on different semantic vector models, wherein determining the first description objects according to the one or more candidate vector sets and the number of the one or more candidate vector sets comprises:
performing weighting processing on the initial similarity of each second semantic vector according to a corresponding ranking order of the second semantic vector in each candidate vector set, to obtain a reference similarity corresponding to the second semantic vector;
determining a sum of multiple reference similarities corresponding to the second semantic vector as a target similarity of the second semantic vector; and
determining the first description objects according to the target similarity of each second semantic vector.

10. The method according to claim 8, wherein the preset retrieval library comprises aggregated service data, the aggregated service data comprises multiple service description objects, and the multiple service description objects are associated with the multiple second semantic vectors, wherein determining the first description objects according to the target similarity of each second semantic vector comprises:
ranking the multiple second semantic vectors according to the target similarity of each second semantic vector; and
taking service description objects corresponding to a second number of second semantic vectors ranked in the front as the first description objects.

11. The method according to claim 3, wherein determining the candidate description object according to the first description objects and the second description objects comprises:
determining a first score value of each first description object and a second score value of each second description object based on a preset scoring model, wherein the first score value is used to describe a matching degree corresponding to the first description object and the query sentence, and the second score value is used to describe a matching degree corresponding to the second description object and the query sentence;
ranking the first description objects and the second description objects according to the first score value of each first description object and the second score value of each second description object; and
taking a third number of first description objects and/or second description objects ranked in the front as candidate description objects.

12. The method according to claim 11, wherein the preset scoring model is obtained by training in a following manner:
obtaining sample data, wherein, the sample data comprises: a sample query sentence and multiple sample replay sentences corresponding to the sample query sentence;
determining a service scenario corresponding to the query sentence;
labeling the multiple sample replay sentences according to the service scenario to determine positive sample reply sentences and negative sample reply sentences from the multiple sample reply sentences; and
training an initial scoring model based on the sample query sentence, the positive sample reply sentences and the negative sample reply sentences to obtain the preset scoring model.

13. (canceled)

14. An electronic device, comprising:
at least one processor; and
a memory communicatively coupled to the at least one processor; wherein,
the memory is stored with instructions executable by the at least one processor, wherein the at least one processor is configured to:
obtain a query sentence, wherein the query sentence has at least one candidate description object;
perform semantic recognition on the query sentence to obtain first semantic information and second semantic information corresponding to the query sentence, wherein categories of the first semantic information and the second semantic information are different;
input the at least one candidate description object and the first semantic information into a large model, to identify a target description object from the at least one candidate description object based on the large model;
select target service data from at least one piece of service data corresponding to the target description object based on the second semantic information; and
generate a reply sentence corresponding to the query sentence according to the target service data.

15. (canceled)

16. (canceled)

17. The electronic device according to claim 14, wherein the first semantic information is semantic information of a geographic area dimension; and the second semantic information is semantic information of a statistical frequency dimension related to the candidate description object, and/or semantic information of a statistical time dimension related to the candidate description object.

18. The electronic device according to claim 14, wherein the at least one candidate description object is determined based on a following manner:
obtaining one or more first semantic vectors and a first keyword corresponding to the query sentence;
determining first description objects matching the one or more first semantic vectors and second description objects matching the first keyword from a preset retrieval library; and
determining the candidate description object according to the first description objects and the second description objects.

19. The electronic device according to claim 18, wherein the preset retrieval library is constructed based on a following manner:
obtaining a service database, wherein the service database comprises multiple pieces of initial service data;
determining service description objects of the initial service data, and data record types and data record frequencies corresponding to the service description objects;
performing aggregation processing on the multiple pieces of initial service data based on the service description objects, the data record types, and the data recording frequencies, to obtain aggregated service data, wherein the aggregated service data comprises the at least one piece of service data corresponding to the target description object;
performing vectorization processing on the service description objects based on a semantic vector model, to obtain a second semantic vector; and
constructing the preset retrieval library based on the aggregated service data and the second semantic vector.

20. The electronic device according to claim 19, wherein the at least one processor is configured to:
perform the vectorization processing on the service description objects based on a monolingual semantic vector model, to obtain the second semantic vector; and/or
perform the vectorization processing on the service description objects based on a multilingual semantic vector model, to obtain the second semantic vector.

21. The electronic device according to claim 18, wherein the at least one processor is configured to:
perform vectorization processing on the query sentence based on a monolingual semantic vector model, to obtain a first semantic vector; and/or
perform the vectorization processing on the query sentence based on a multilingual semantic vector model, to obtain a first semantic vector.

22. The electronic device according to claim 18, wherein the preset retrieval library comprises: multiple second semantic vectors, wherein the at least one processor is configured to:
determine an initial similarity between a first semantic vector and each second semantic vector in the preset retrieval library;
rank the multiple second semantic vectors according to initial similarities;
construct a candidate vector set corresponding to the first semantic vector according to a first number of second semantic vectors ranked in the front; and
determine the first description objects according to one or more candidate vector sets and a number of the one or more candidate vector sets.

23. The electronic device according to claim 18, wherein the at least one processor is configured to:
determine a first score value of each first description object and a second score value of each second description object based on a preset scoring model, wherein the first score value is used to describe a matching degree corresponding to the first description object and the query sentence, and the second score value is used to describe a matching degree corresponding to the second description object and the query sentence;
rank the first description objects and the second description objects according to the first score value of each first description object and the second score value of each second description object; and
take a third number of first description objects and/or second description objects ranked in the front as candidate description objects.
